(19) United States
(12) Patent Application Publication
(10) Pub. No.: US 2026/0346259 A1
(43) Pub. Date: Nov. 5, 2026

(54) WEAR LINER COMPRISING WEAR RESISTANT INSERTS, METHODS OF PRODUCING WEAR LINER THEREOF AND A CONE CRUSHER COMPRISING SAID WEAR LINER

(71) Applicant: METSO FINLAND OY, Espoo (FI)

(72) Inventor: Juuso Terva, Lempäälä (FI)

(73) Assignee: METSO FINLAND OY, Espoo (FI)

(21) Appl. No.: 19/486,186

(22) PCT Filed: May 23, 2024
(86) PCT No.: PCT/EP2024/064156

§ 371 Date: Nov. 20, 2025

(30) Foreign Application Priority Data
May 23, 2023 (SE) 2350621-5

(51) Int. Cl. B02C 2/00

(52) U.S. Cl. CPC B02C 2/005

(57) ABSTRACT

A wear liner for a cone crusher. The wear liner includes a main body having a circumferential extension extending around a central longitudinal axis and has an elongated extension from a first axial end to a second axial end. The main body includes a crushing surface to contact material to be crushed. The crushing surface is inclined with respect to the central longitudinal axis. The main body further has wear resistant inserts embedded therein to strengthen the crushing surface. The wear resistant inserts have an elongated extension from a first end to a second end, and the elongated extension of the wear resistant inserts is arranged at an angle to a normal of the crushing surface. A cone crusher can be configured to include at least one wear liner described, and methods for producing such a wear liner are provided.

### CROSS-REFERENCE TO RELATED APPLICATIONS

This application is the U.S. national stage application of International Application PCT/EP2024/064156, filed May 23, 2024, which international application was published on Nov. 28, 2024, as International Publication WO 2024/240851 A1 in the English language. The International Application claims priority to Swedish Patent Application No. 2350621-5 filed May 23, 2023.

### FIELD OF THE INVENTION

The present disclosure relates to a wear liner for a cone crusher. The present disclosure also relates to a cone crusher comprising at least one wear liner of the disclosure.

### BACKGROUND

Cone crushers and gyratory crushers are used for crushing ore, mineral and rock material to smaller sizes in a crushing gap between a stationary element and a moving element. Cone crusher and gyratory crushers typically comprise, as moving element, a head assembly including a crusher head or a main shaft, and, as stationary element, a bowl attached to a main frame of the cone crusher or, for larger gyratory crushers, a main frame holding concave segments. A gyratory pendulum movement is imparted to the moving element about a vertical axis within the stationary element, which crushes rock, stone or other material as it travels through the crushing gap. The crushed material exits the cone or gyratory crusher through the bottom of the crushing gap.

A challenge faced with cone and gyratory crushers is that the crushing process results in an excessive wear of the crushing surfaces forming the crushing gap. For this purpose, both the moving element and the stationary element are equipped with wear liners made from a wear-resistant material, such as e.g. manganese steel, to form the crushing surfaces defining the crushing gap. Wear liners for the moving element are typically referred to as a mantle or mantle liners, whereas wear liners for the stationary element typically are referred to as bowl liners or concave liners. It should be noted in this respect that the stationary element of cone crushers, typically called the bowl, is stationary during the crushing process, but is moveable in the vertical direction to be able to adjust for wear and tear of the wear surfaces and this adjustment is typically done when no crushing is taking place. In gyratory crushers, the stationary element is stationary at all times and the corresponding adjustment is made by moving the moving element, i.e. the crusher head or, for larger primary crushers, the main shaft, in the vertical direction.

Apart from the wear liner being made of wear-resistant material, such as e.g. manganese steel, the wear liners may also comprise zones having higher resistance to abrasion than the remaining parts of the wear liners. This may be accomplished by having abrasion resistant inserts embedded in the wear liner in these zones. However, even though the use of such abrasion resistant inserts has improved the wear life of wear liners, there is still a need for further improvements, especially as implementation of such abrasion resistant inserts in wear liners increases the cost of the wear liner.

Proceeding therefrom, it is an object of the present disclosure to further improve the wear life of wear liners for cone and gyratory crushers in comparison of what has been disclosed within prior art.

### SUMMARY

According to a first aspect of the present disclosure, this and other objects are achieved, in full or at least in part, by a wear liner for a cone crusher comprising a main body having a circumferential extension extending around a central longitudinal axis and having an elongated extension from a first axial end to a second axial end. The main body comprises a crushing surface to contact material to be crushed, which crushing surface is inclined with respect to the central longitudinal axis. The main body further comprises wear resistant inserts embedded in the main body to strengthen the crushing surface. According to the disclosure, the wear resistant inserts have an elongated extension from a first end to a second end, and the elongated extension of the wear resistant inserts is arranged at an angle to a normal of the crushing surface.

The term “cone crusher” as used herein should be construed broadly to encompass both gyratory crushers typically used for larger rocks, including primary gyratory crushers, and cone crushers typically used for smaller rocks.

The term “main body” as used herein should be construed broadly to encompass both a single piece main body and a main body composed of multiple liner elements together forming a main body. Thus, according to some embodiments, the main body of the wear liner is provided as a single piece. According to some embodiments, the main body of the wear liner is composed of a plurality of liner elements.

The crushing surface of the main body may have a continuous inclination with respect to the central longitudinal axis or it may be inclined at different angles with respect to the central longitudinal axis at different portions of the main body. It may further have a continuously changing inclination with respect to the central longitudinal axis, e.g. it may be curved.

Wear resistant inserts are within prior art arranged with the elongated extension aligned with a normal of the crushing surface. The phrase “a (or the) normal to the crushing surface” as used herein is a phrase part of common general knowledge and is known to correspond to about a 90° angle, i.e. perpendicular to the crushing surface.

By having the elongated extension of wear resistant inserts arranged at an angle to the normal of the crushing surface, the wear life of the wear liner is improved. The angles of the elongated extension of the different wear resistant inserts may be disordered and random, such that the angles at which the elongated extension of the wear resistant inserts deviate from the normal to the crushing surface are randomly distributed, so that the wear resistant inserts are very irregularly embedded in the main body. However, having the elongated extension of the wear resistant inserts arranged at one or more preferred angles to a normal of the crushing surface may improve the wear life of the wear liner even further.

In wear liners for cone crushers, the wear resistant inserts are normally embedded completely within the main body but having a first end at or in a proximity to the crushing surface of the wear liner. As the wear liner is worn down during use, the material of the main body, which also may be termed as a matrix material of the main body, which material surrounds the wear resistant inserts, will start to wear down leaving the first ends of the wear resistant inserts exposed outside of the main body. However, the wear resistant inserts may also be arranged and embedded in the main body such that the first end of the wear resistant inserts to some extent extends outside of the main body already before being used and worn.

For sufficiency, examples of material for the main body are steels such as manganese steel, e.g. Hadfield steel. Other examples of material for the main body are cast irons, such as white cast iron and particularly high chromium white iron, low alloyed steel, or mixtures thereof.

For sufficiency, examples of material for the wear resistant inserts are steels, such as manganese steel, e.g. high manganese austenitic steel or low manganese steel, high chromium white cast iron, tool steel, cermets, and metal matrix composites. Typically, the material for the wear resistant inserts is more wear resistant, particularly harder, than the material used for the main body. However, it is also possible to provide wear resistant inserts of the same material as the material for the main body. When the wear resistant inserts and the main body is provided in the same material, e.g. of manganese steel, the material of the wear resistant inserts will be provided with higher hardness than that of the main body, such to provide a higher wear resistance. As referred to herein, the term “cermet” as used herein refers to composite materials composed of ceramic and metal materials, wherein the metal material constitutes up to 20% by volume of the composite material, whereas the term “metal matrix composite” as used herein refers to composite materials composed of ceramic and metal materials, wherein the metal material constitutes more than 20% by volume of the composite material.

For sufficiency, non-exhaustive examples of shapes of the wear resistant inserts are cylindrical, rectangular, and ellipsoidal.

According to some embodiments of the wear liner of the disclosure, the angle to the normal of the crushing surface is within the range of 5°-45°, 8°-45°, 10°-45°, 16°-45° or 16°-30°. Arranging the elongated extension of the wear resistant inserts at an angle to the normal of the crushing surface within an upper part of the exemplifying range of 5°-45°, e.g. within 16°-45°, particularly increases the surface area of the wear resistant inserts that is exposed to wear from the material to crush as the wear liner is worn, thereby increasing wear resistance of the wear liner.

According to some embodiments of the wear liner of the disclosure, the elongated extension of the wear resistant inserts is arranged at an angle to the normal of the crushing surface in a plane parallel with the central longitudinal axis and/or in a plane perpendicular to the central longitudinal axis.

According to some embodiments of the wear liner of the disclosure, the wear resistant inserts are embedded in the main body at the crushing surface in a pattern, wherein the pattern is formed by the first ends of the wear resistant inserts arranged at or in the proximity to the crushing surface arranged in rows aligned with the elongated extension of the main body, and wherein the rows are arranged with a repeated distance around the circumferential extension of the main body.

### SUBSTITUTE SPECIFICATION-CLEAN

According to some embodiments of the wear liner of the disclosure, the rows may be arranged such that the first ends of the wear resistant inserts of different rows align with each other in a plane perpendicular to the central longitudinal axis. In other embodiments of the wear liner of the disclosure, the rows may be arranged such that the first ends of the wear resistant inserts of adjacent rows are staggered such that the first ends of the wear resistant inserts of every second row are aligned with each other in a plane perpendicular to the central longitudinal axis.

According to some embodiments of the wear liner of the disclosure, the wear resistant inserts are embedded in the main body at the crushing surface in a pattern, wherein the pattern is formed by the first ends of the wear resistant inserts arranged at or in the proximity to the crushing surface arranged in rows aligned with the elongated extension of the main body and distributed around the circumferential extension of the main body, and wherein the rows are arranged around the circumferential extension of the main body with a repeated distance regularly interrupted by a blank distance which is larger than the repeated distance. The blank distance may be repeated at least every 10th row, at least every 8th row, at least every 6th row, at least every 4th row, or at least every 3rd row. Further, the blank distance may correspond to a distance of at least one removed row of wear resistant inserts including the repeated distances thereof. Providing a pattern with blank distances allows reducing the amount of wear resistant inserts in the main body, which is advantageous in a cost perspective. In combination with the wear resistant inserts being provided with the elongated extension at an angle to the normal of the crushing surface, according to this exemplifying embodiment, the wear resistance of the wear liner is actually improved despite the number of wear resistant inserts being reduced.

Although having a specific pattern of the first end of the wear resistant inserts within the main body, the elongated extension of the wear resistant inserts may be arranged at an angle to the normal of the crushing surface, which angle may be disordered and random as disclosed above or may be one or more preferred angles in a plane parallel with the central longitudinal axis and/or in a plane perpendicular to the central longitudinal axis. Providing the wear resistant inserts embedded in the main body at the crushing surface randomly, without a specific pattern formed by the first ends of the wear resistant inserts arranged at or in the proximity to the crushing surface is also possible within the concept of the present disclosure.

According to some embodiments of the wear liner of the disclosure, the wear liner is an outer wear liner, wherein the crushing surface is provided at a radially inward facing surface of the wear liner, and wherein the outer wear liner during crushing is fixably mounted in a cone crusher for interaction with a moving element of the cone crusher, such as a cone crusher head or a main shaft, which is arranged to rotate around its own central axis in a first rotational direction.

The term “outer wear liner” as used herein means a wear liner arranged at a stationary element of a cone crusher, such as a stationary bowl, or a concave segment, attached to a main frame of the cone crusher. Thus, in an embodiment, the outer wear liner is a bowl liner or a concave liner.

Being an outer wear liner, the elongated extension of the wear resistant inserts may, in comparison to the normal of the crushing surface, be inclined, in a plane parallel with the central longitudinal axis, towards the first axial end of the main body. Having such an orientation of the wear resistant inserts, any axially directed crushing forces acting upon the wear resistant inserts at the crushing surface, during crushing operation, will more likely be absorbed in the direction of the elongated extension of the wear resistant inserts, in which direction the wear resistant insert are well supported and embedded in the main body. Having that said, the elongated extension of the wear resistant inserts does not necessarily have to completely align with the direction of the crushing forces acting upon the wear liner in order to provide improved wear life of the wear liner.

Providing the wear resistant inserts having an orientation which is essentially aligned with the crushing forces acting upon the crushing surface during use of the wear liner in a cone crusher is further advantageous in that an improved wear profile of the wear liner, particularly around the wear resistant inserts, will be provided when the wear liner is worn. With the wear resistant inserts having their elongated extension at an angle to the normal of the crushing surface, the first end of each wear resistant insert will be worn more evenly with the crushing surface. As material of the main body is worn off around the wear resistant inserts during use, the wear resistant inserts will protrude and expose ellipse-shaped wear profiles with smooth edges. This is opposite of having the elongated extension of the wear resistant inserts aligned with the normal of the crushing surface, as in the prior art wear liners for cone crushers, which when the wear liner is worn protrude perpendicularly to the crushing surface exposing essentially circular cross-sections. The circular cross-sections thus protrude perpendicularly to the flow of crushing material, causing build-up of material around the wear resistant inserts, further leading to more severe wear of the wear liner.

Further, being an outer wear liner, the elongated extension of the wear resistant inserts may be arranged at an angle to a normal of the crushing surface in a plane perpendicular to the central longitudinal axis and the first end of the wear resistant insert, at or in the proximity to the crushing surface, may be arranged as a leading end in relation to a rotational direction of an interacting moving element of the cone crusher during crushing operation.

The phrase “leading end in relation to a rotational direction of an interacting moving element of the cone crusher during crushing operation” as used herein means that the first end of the wear resistant inserts is directed such that the elongated extension of the wear resistant inserts may be more aligned with the impact forces acting upon the outer wear liner during crushing in the plane perpendicular to the central longitudinal axis. Thus, any crushing forces acting upon the first end of the wear resistant insert will more likely be absorbed in the direction of the elongated extension of the wear resistant insert, in which direction the wear resistant inserts are well supported and embedded in the material of the main body. This is opposite of having impact forces being absorbed in the wear liner to encounter a surface along an elongated extension of a wear insert, which may lead to shear stresses possibly resulting in material excavations from the wear liner surface. Having that said, the elongated extension of the wear resistant inserts does not necessarily have to completely align with the direction of the crushing forces acting upon the wear liner in order to provide improved wear life of the wear liner. As previously described, arranging the wear resistant inserts essentially aligned with the impact forces acting upon the crushing surface of the wear liner during crushing further provides an improved wear profile of the wear liner.

According to some embodiments of the wear liner of the disclosure, the wear liner is an inner wear liner, wherein the crushing surface is provided at a radially outward facing surface of the wear liner, and wherein the inner wear liner during crushing operation will rotate around its own central longitudinal axis in a rotational direction.

The term “inner wear liner” as used herein means the wear liner arranged on the moving element of the cone crusher that gyrates about a vertical axis within the stationary element attached to the main frame of the cone crusher. Thus, during crushing operation, the inner wear liner will rotate with the moving element of the cone crusher about the vertical axis in a rotational direction. Another term for such an inner wear liner is a mantle or a mantle liner. Thus, in an embodiment, the inner wear liner is a mantle or a mantle liner.

Being an inner wear liner, the elongated extension of the wear resistant inserts may, in comparison to the normal of the crushing surface, be inclined in a plane parallel with the central longitudinal axis towards the second axial end of the main body. Having such an orientation of the wear resistant inserts, any axially directed crushing forces acting upon the wear resistant inserts at the crushing surface, during crushing operation, will more likely be absorbed in the direction of the elongated extension of the wear resistant inserts, in which direction the wear resistant inserts are well supported and embedded in the main body. Having that said, the elongated extension of the wear resistant inserts does not necessarily have to completely align with the direction of the crushing forces acting upon the wear liner in order to provide improved wear life of the wear liner.

As described with reference to previous embodiments, providing the wear resistant inserts having an orientation which is essentially aligned with the crushing forces acting upon the crushing surface during use of the wear liner in a cone crusher is further advantageous in that an improved wear profile of the wear liner, particularly around the wear resistant inserts, will be provided when the wear liner is worn. With the wear resistant inserts having their elongated extension at an angle to the normal of the crushing surface, the first end of each wear resistant insert will be worn more evenly with the crushing surface. As material of the main body is worn off around the wear resistant inserts during use, the wear resistant inserts will protrude and expose ellipse-shaped wear profiles with smooth edges, thus providing the improved wear profile.

Further, the wear liner being an inner wear liner, the elongated extension of the wear resistant inserts may be arranged at an angle to a normal of the crushing surface in a plane perpendicular to the central longitudinal axis and the first end of the wear resistant insert, at or in the proximity to the crushing surface may be arranged as a leading end in relation to a rotational direction of the inner wear liner during crushing operation.

The phrase “leading end in relation to a rotational direction of the inner wear liner during crushing operation” as used herein means that the first end of the wear resistant inserts is directed such that the elongated extension of the wear resistant inserts may be more aligned with the impact forces acting upon the inner wear liner during crushing operation in the plane perpendicular to the central longitudinal axis. Thus, any crushing forces acting upon the first end of the wear resistant insert will more likely be absorbed in the direction of the elongated extension of the wear resistant insert, in which direction the wear resistant inserts are well supported and embedded in the material of the main body. This is opposite of having impact forces being absorbed in the wear liner to encounter a surface along an elongated extension of a wear resistant insert, which may lead to shear stresses possibly resulting in material excavations from the wear liner surface. Again, having that said, the elongated extension of the wear resistant inserts does not have to completely align with the direction of the crushing forces acting upon the wear liner in order to provide improved wear life of the wear liner. As previously described, arranging the wear resistant inserts essentially aligned with the impact forces acting upon the crushing surface of the wear liner during crushing further provides an improved wear profile of the wear liner.

According to a second aspect of the present disclosure, this and other objects are achieved, in full or at least in part, by a cone crusher comprising at least one wear liner according to any one of the above disclosed embodiments of the wear liner.

According to a third aspect of the present disclosure, this and other objects are achieved in full or at least in part, by a method of producing a wear liner for a cone crusher as disclosed herein. The method comprises the steps of providing a mould for casting the wear liner therein; arranging wear resistant inserts having an elongated extension in the mould at a surface of the mould corresponding to a crushing surface of the wear liner; pouring molten matrix material into the mould such that the molten matrix material surrounds the wear resistant inserts and; allowing the matrix material to solidify, thereby obtaining a wear liner comprising wear resistant inserts bonded to the solidified matrix material, wherein the step of arranging the wear resistant inserts in the mould comprises arranging the elongated extension of the wear resistant inserts at an angle to a normal of the mould surface.

According to a fourth aspect of the present disclosure, this and other objects are achieved in full or at least in part by a method of producing a wear liner for a cone crusher as disclosed herein. The method comprises the steps of providing a main body of a wear liner; forming holes in a crushing surface of the wear liner for receiving wear resistant inserts therein; and fixedly inserting wear resistant inserts having an elongated extension into the holes, wherein the step of forming holes comprises forming an elongated extension of the holes which elongated extension is at an angle to a normal of the crushing surface of the wear liner, such that upon insertion of the wear resistant inserts in the holes, the elongated extension of the wear resistant inserts is at an angle to a normal of the crushing surface of the wear liner.

Effects and features of the second, third, and fourth aspects are largely analogous to those described above in connection with the first aspect. Embodiments mentioned in relation to the first aspect are largely compatible with the second, third, and fourth aspects. It is further noted that the inventive concepts relate to all possible combinations of features unless explicitly stated otherwise.

Other objectives, features and advantages of the present disclosure will appear from the following detailed disclosure, from the attached claims, as well as from the drawings. It is noted that the present disclosure relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

As used herein, the term “comprising” and variations of that term are not intended to exclude other additives, components, integers or steps.

### BRIEF DESCRIPTION OF THE DRAWINGS

The present disclosure will be described in more detail with reference to the appended schematic drawings, which show an example of a presently preferred embodiment of the disclosure.

FIG. 1 is a cross-sectional side view of an outer and an inner wear liner according to prior art.

FIG. 2 is a cross-sectional side view of an outer and an inner wear liner according to one embodiment of the disclosure.

FIG. 3 is a partial cross-sectional side view of an inner wear liner according to one embodiment of the disclosure.

FIG. 4 is a partial cross-sectional top view of the inner wear liner of FIG. 3.

FIG. 5 is a partial cross-sectional side view of an outer and an inner wear liner according to yet another embodiment of the disclosure.

FIG. 6 is a partial cross-sectional side view of an outer and an inner wear liner according to yet another embodiment of the disclosure.

FIG. 7a is a partial side view of a crushing surface of an inner wear liner showing a pattern of wear resistant inserts according to one embodiment of the disclosure.

FIG. 7b is a partial side view of a crushing surface of an inner wear liner showing a pattern of wear resistant inserts according to another embodiment of the disclosure.

FIG. 7c is a partial side view of a crushing surface of an inner wear liner showing a pattern of wear resistant inserts according to yet another embodiment of the disclosure.

FIG. 7d is a partial side view of a crushing surface of an inner wear liner showing a pattern of wear resistant inserts according to another embodiment of the disclosure.

FIG. 7e is a partial side view of a crushing surface of an inner wear liner showing a pattern of wear resistant inserts according to yet another embodiment of the disclosure.

FIG. 7f is a partial side view of a crushing surface of an inner wear liner showing a pattern of wear resistant inserts according to yet another embodiment of the disclosure.

FIG. 8a is a flow chart for a method according to one embodiment of the third aspect of the present disclosure.

FIG. 8b is a flow chart for a method according to an embodiment of the fourth aspect of the present disclosure.

### DETAILED DESCRIPTION

The present disclosure will now be described more fully hereinafter with reference to the accompanying drawings, in which currently preferred embodiments of the present disclosure are shown. The present disclosure may, however, be embodied in many different forms and should not be construed as limited to the embodiments set forth herein; rather, these embodiments are provided for thoroughness and completeness, and to fully convey the scope of the present disclosure to the skilled addressee. Like reference characters refer to like elements throughout.

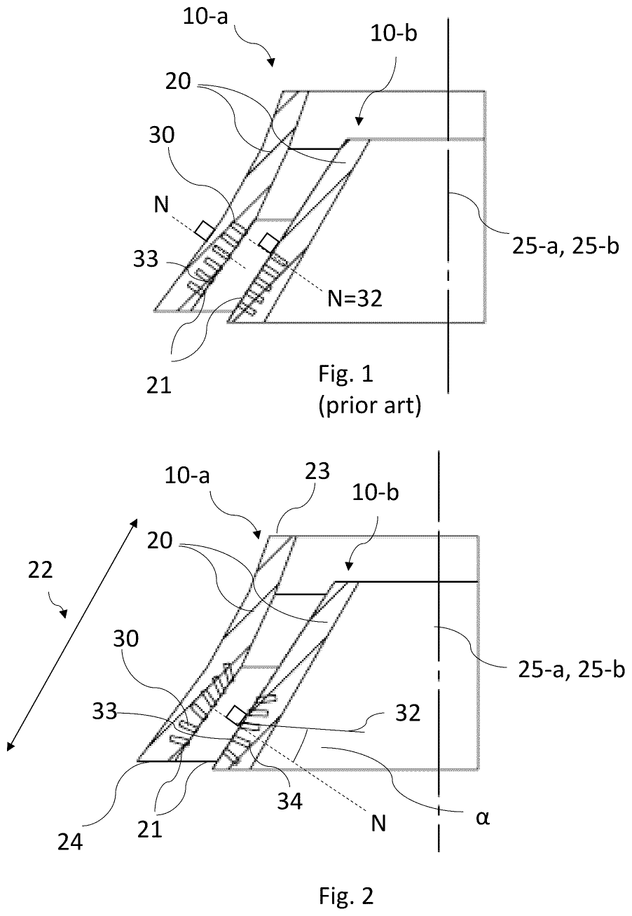

FIG. 1 shows a cross-sectional side view of an outer wear liner 10-a and an inner wear liner 10-b according to prior art. The wear liners 10-a, 10-b have wear resistant inserts 30 arranged with a first end 33 at a crushing surface 21 of the main bodies 20 thereof. An elongated extension 32 of the wear resistant inserts 30 is arranged to be aligned with a normal N of the crushing surface 21 in both wear liners 10-a, 10-b. Thus, the elongated extension 32 of the wear resistant inserts 30 is arranged perpendicular (90°) to the crushing surface 21 in both wear liners 10-a, 10-b.

FIG. 2 shows a cross-sectional side view of an outer wear liner 10-a and an inner wear liner 10-b according to an embodiment of the disclosure. The wear liners 10-a, 10-b each comprises a main body 20 having a circumferential extension extending around a central longitudinal axis 25-a, 25-b and having an elongated extension 22 from a first axial end 23 to a second axial end 24. Each main body 20 comprises a crushing surface 21 to contact material to be crushed, which crushing surface 21 is inclined with respect to the central longitudinal axis 25-a, 25-b. In this embodiment, the second axial end 24 has a larger diameter than the first axial end 23. Each main body 20 further comprises wear resistant inserts 30 embedded in the main body 20 to strengthen the crushing surface 21. According to the disclosure the wear resistant inserts 30 each has an elongated extension 32 from a first end 33 to a second end 34, and the elongated extension 32 of the wear resistant inserts 30 is arranged at an angle α to a normal N of the crushing surface 21. As shown in FIG. 2, the angles α of the elongated extension 32 of the different wear resistant inserts 30 are disordered and random but do all deviate from the normal N of the crushing surface 21. Thus, in the shown embodiment of FIG. 2, the wear resistant inserts 30 are irregularly embedded in the main body 20. An arrangement of the wear inserts 30 as shown in FIG. 2, will improve the wear life of the wear liner 10-a, 10-b. It is believed that the reason behind this is that as the crushing forces are acting upon the crushing surface 21, the crushing forces will be absorbed by the wear resistant inserts 30 along the elongated extensions into different directions within the main body 20, and thereby even out the crushing forces within the main body 20. However, as disclosed above in the summary part, having the elongated extension 32 of the wear resistant inserts 30 arranged at one or more preferred angles to a normal of the crushing surface 21 will also improve the wear life of the wear liner 10-a, 10-b.

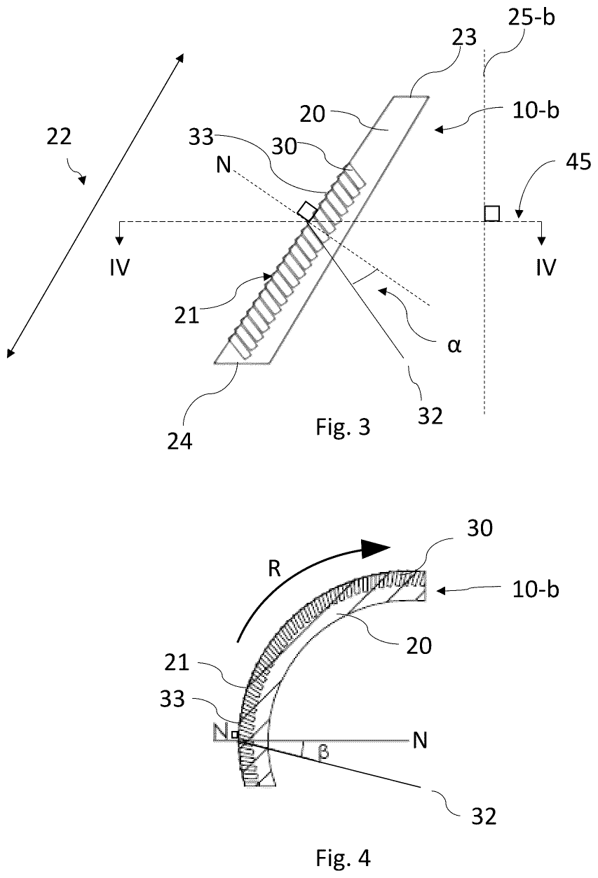

FIG. 3 shows a partial cross-sectional side view of an inner wear liner 10-b according to an embodiment of the disclosure. In FIG. 3 it is shown how the elongated extension 32 of the wear resistant inserts 30 are arranged at an angle α to the normal of the crushing surface in a plane parallel with the central longitudinal axis 25-b. The angles α for the wear resistant inserts 30 are chosen such that the elongated extension 32 of the wear resistant inserts 30 more or less is arranged to align with the direction of the crushing forces acting upon the crushing surface 21 encountering the axial flow of material along the crushing surface 21 in a direction from the first axial end 23 towards the second axial end 24 of the main body 20. Thus, the crushing forces acting upon the first end 33 of the wear resistant insert 30 will more likely be absorbed in the direction of the elongated extension 32 of the wear resistant insert 30, in which direction the wear resistant inserts 30 are well supported and embedded in the material of the main body 20.

Further, when the wear liner 10-b starts to become worn, the first end 33 of the wear resistant inserts 30 will wear more evenly with the crushing surface 21 and expose an ellipse-shaped wear profile with smooth edges. This is opposite of having the elongated extension 32 of the wear resistant inserts 30 aligned with the normal N of the crushing surface 21, as in the prior art wear liners 10-a, 10-b for cone crushers, wherein when the wear liner 10-a, 10-b is worn the first ends 33 of the wear resistant inserts 30 project perpendicularly to the crushing surface 21. This causes build-up of material around the projecting wear resistant inserts 30, leading to more severe wear of the wear liner 10-a, 10-b.

FIG. 4 shows a partial cross-sectional view of a plane perpendicular 45 with the central longitudinal axis 25-b along section IV-IV of FIG. 3. In FIG. 4 it is shown how the elongated extensions 32 of the wear resistant inserts 30 further are arranged at an angle B to the normal N of the crushing surface 21 in a plane perpendicular 45 with the central longitudinal axis 25-b. FIG. 4 also shows a suggested rotational direction R of the inner wear liner 10-b fixedly attached to a moving element of a cone crusher (not shown). The angle β is chosen such that the elongated extension 32 of the wear resistant inserts 30 more or less is arranged to align with the direction of the crushing forces acting upon the crushing surface 21 encountering the circumferential flow of material movement along the crushing surface 21. Thus, the crushing forces acting upon the first end 33 of the wear resistant insert 30 will more likely be absorbed in the direction of the elongated extension 32 of the wear resistant insert 30, in which direction the wear resistant inserts 30 are well supported and embedded in the material of the main body 20.

Thus, the embodiment of the inner wear liner 10-b shown in FIGS. 3 and 4, has wear resistant inserts 30 which elongated extensions 32 are arranged at an angle α, β to the normal N of the crushing surface 21 both in the plane parallel with the central longitudinal axis 25-b and in the plane perpendicular 45 to the central longitudinal axis 25-b. With this arrangement, the wear resistant inserts 30 may encounter both the axial and circumferential flow of material movement along the crushing surface 21.

However, arranging the wear resistant inserts with deviation in only one plane thereof will also improve the wear life of the wear liner.

Further, when the wear liner 10-b starts to become worn, the first end 33 of the wear resistant inserts 30 will wear more evenly with the crushing surface 21, as described with reference to previous embodiments, and expose an ellipse-shaped wear profile. In addition to providing a smoother wear profile, the end surface of the wear resistant inserts 30 thus exposed is larger than that provided by wear resistant inserts 30 arranged with their elongated extension 32 aligned with the normal N to the crushing surface 21 when worn, thus providing a larger surface of wear resistant material in the crushing surface 21.

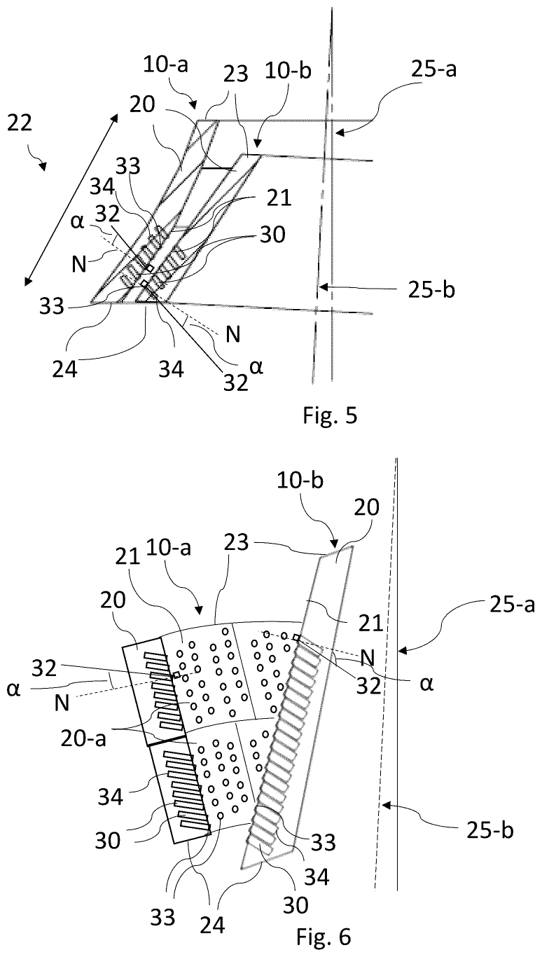

FIG. 5 shows a partial cross-sectional side view of an outer wear liner 10-a and an inner wear liner 10-b according to an embodiment of the disclosure. Again, the wear liners 10-a, 10-b each comprises a main body 20 having a circumferential extension extending around a central longitudinal axis 25-a, 25-b and having an elongated extension 22 from a first axial end 23 to a second axial end 24. Each main body 20 comprises a crushing surface 21 to contact material to be crushed, which crushing surface 21 is inclined with respect to the central longitudinal axis 25-a, 25-b. Also in this embodiment, the second axial end 24 has a larger diameter than the first axial end 23. Each main body 20 further comprises wear resistant inserts 30 embedded in the main body 20 to strengthen the crushing surface 21. The wear resistant inserts 30 each has an elongated extension 32 from a first end 33 to a second end 34, and the elongated extension 32 of the wear resistant inserts 30 is arranged at an angle α to a normal N of the crushing surface 21. As shown in FIG. 5, the elongated extension 32 of the wear resistant inserts 30 of the outer wear liner 10-a is, in comparison to the normal N of the crushing surface 21, inclined, in a plane parallel with the central longitudinal axis 25-a, towards the first axial end 23 of the main body 20 of the outer wear liner 10-a. In this exemplifying embodiment, the elongated extension 32 of the wear resistant inserts 30 of the outer wear liner 10-a is, in comparison with the normal N of the crushing surface 21, inclined towards the first axial end 23 of the main body 20 with an angle α. Further as shown in FIG. 5, the elongated extension 32 of the wear resistant inserts 30 of the inner wear liner 10-b is, in comparison to the normal N of the crushing surface 21, inclined, in a plane parallel with the central longitudinal axis 25-b, towards the second axial end 24 of the main body 20 of the inner wear liner 10-b. In this exemplifying embodiment, the elongated extension 32 of the wear resistant inserts 30 of the inner wear liner 10-b is inclined towards the second axial end 24 of the main body 20 with an angle α. The angles α for the outer wear liner 10-a and the inner wear liner 10-b are chosen such that the elongated extension 32 of the wear resistant inserts 30 more or less is arranged to align with the directions of the crushing forces acting upon the crushing surfaces 21 encountering the axial flow of material along the crushing surfaces 21 in a direction from the first axial end 23 towards the second axial end 24 of the main bodies 20. The outer wear liner 10-a generally encounters forces directed towards the first axial end 23 of the main body 20 of the outer wear liner 10-a, and the inner wear liner 10-b encounters forces directed towards the second axial end 24 of the main body 20 of the inner wear liner 10-b when the material to be crushed is squeezed in-between the two wear liners 10-a, 10-b. Thus, the crushing forces acting upon the first ends 33 of the wear resistant inserts 30 will more likely be absorbed in the direction of the elongated extensions 32 of the wear resistant inserts 30, in which directions the wear resistant inserts 30 are well supported and embedded in the material of the main bodies 20 of the outer wear liner 10-a, and the inner wear liner 10-b. Further, the angles α for the outer wear liner 10-a may thus be the same or differ from the angles α for the inner wear liner 10-b, based on the directions of the crushing forces acting upon the crushing surface 21 of the respective wear liner 10-a, 10-b.

Further, as disclosed in connection with FIG. 4, the elongated extension 32 of the wear resistant inserts 30 may further be arranged at an angle β to the normal N of the crushing surface 21 in a plane perpendicular 45 with the central longitudinal axis 25-a in the outer wear liner 10-a as well as in the inner wear liner 10-b.

Further, when the wear liners 10-a, 10-b start to become worn, the first end 33 of the wear resistant inserts 30 will wear more evenly with the crushing surface 21, as described with reference to previous embodiments, and expose an ellipse-shaped wear profile. In addition to providing a smoother wear profile, the end surface of the wear resistant inserts 30 thus exposed is larger than that provided by wear resistant inserts 30 arranged with their elongated extension 32 aligned with the normal N to the crushing surface 21 when worn, thus providing a larger surface of wear resistant material in the crushing surface 21 of the wear liners 10-a, 10-b.

FIG. 6 shows a partial cross-sectional side view of an outer wear liner 10-a and an inner wear liner 10-b according to another embodiment of the disclosure. Again, the wear liners 10-a, 10-b each comprises a main body 20 having a circumferential extension extending around a central longitudinal axis 25-a, 25-b and an elongated extension extending from a first axial end 23 to a second axial end 24. Each main body 20 comprises a crushing surface 21 to contact material to be crushed, which crushing surface 21 is inclined with respect to the central longitudinal axis 25-a, 25-b. In this embodiment, the main body 20 of the outer wear liner 10-a is composed of a plurality of wear liner elements 20-a forming the main body 20 of the outer wear liner 10-a. Further, in this exemplifying embodiment, the second axial end 24 of the main body 20 of the outer wear liner 10-a has a smaller diameter than the first axial end 23 whereas the second axial end 24 of the main body 20 of the inner wear liner 10-b has a larger diameter than the first axial end 23 thereof.

Each main body 20 further comprises wear resistant inserts 30 embedded in the main body 20 to strengthen the crushing surface 21. The wear resistant inserts 30 each has an elongated extension 32 from a first end 33 to a second end 34, and the elongated extension 32 of the wear resistant inserts 30 is arranged at an angle α to a normal N of the crushing surface 21. As shown in FIG. 6, the elongated extension 32 of the wear resistant inserts 30 of the outer wear liner 10-a is, in comparison to the normal N of the crushing surface 21, inclined, in a plane parallel with the central longitudinal axis 25-a, towards the first axial end 23 of the main body 20 of the outer wear liner 10-a. In this exemplifying embodiment, the elongated extension 32 of the wear resistant inserts 30 of the outer wear liner 10-a is, in comparison with the normal N of the crushing surface 21, inclined towards the first axial end 23 of the main body 20 with an angle α. Further as shown in FIG. 6, the elongated extension 32 of the wear resistant inserts 30 of the inner wear liner 10-b is, in comparison to the normal N of the crushing surface 21, inclined, in a plane parallel with the central longitudinal axis 25-b, towards the second axial end 24 of the main body 20 of the inner wear liner 10-b. In this exemplifying embodiment, the elongated extension 32 of the wear resistant inserts 30 of the inner wear liner 10-b is inclined towards the second axial end 24 of the main body 20 with an angle α. The angles α for the outer wear liner 10-a and the inner wear liner 10-b are chosen such that the elongated extension 32 of the wear resistant inserts 30 more or less is arranged to align with the directions of the crushing forces acting upon the respective crushing surfaces 21 encountering the axial flow of material along the crushing surfaces 21 in a direction from the first axial end 23 towards the second axial end 24 of the main bodies 20. The outer wear liner 10-atypically encounters forces directed towards the first axial end 23 of the main body 20 of the outer wear liner 10-a, and the inner wear liner 10-b typically encounters forces directed towards the second axial end 24 of the main body 20 of the inner wear liner 10-b when the material to be crushed is squeezed in-between the two wear liners 10-a, 10-b. Thus, the crushing forces acting upon the first ends 33 of the wear resistant inserts 30 will more likely be absorbed in the direction of the elongated extensions 32 of the wear resistant inserts 30, in which directions the wear resistant inserts 30 are well supported and embedded in the material of the main bodies 20 of the outer wear liner 10-a, and the inner wear liner 10-b. Further, the angles α for the outer wear liner 10-a may thus be the same or differ from the angles α for the inner wear liner 10-b, based on the directions of the crushing forces acting upon the crushing surface 21 of the respective wear liner 10-a, 10-b. The angle α may further differ between wear resistant inserts 30 in one same wear liner 10-a, 10-b or between wear resistant inserts 30 of different wear liner elements 20-a, based on the direction of the crushing forces acting upon the crushing surface 21 of the main body 20 of the wear liner 10-a, 10-b, or of the wear liner elements 20-a forming the main body 20. Considering that the direction of the crushing forces typically is not continuous but differs along the crushing surface 21 of the main body 20 of the wear liner 10-a, 10-b, the present disclosure is advantageous in that it can be adapted accordingly by adjusting the angle α with which the wear resistant inserts 30 are inclined based on the same.

Further, as disclosed in connection with FIG. 4, the elongated extension 32 of the wear resistant inserts 30 in the embodiment of FIG. 6 may further be arranged at an angle B to the normal N of the crushing surface 21 in a plane perpendicular 45 with the central longitudinal axis 25-a in the outer wear liner 10-a as well as in the inner wear liner 10-b.

Further, when the wear liners 10-a, 10-b start to become worn, the first end 33 of the wear resistant inserts 30 will wear more evenly with the crushing surface 21, as described with reference to previous embodiments, and expose an ellipse-shaped wear profile. In addition to providing a smoother wear profile, the end surface of the wear resistant inserts 30 thus exposed is larger than that provided by wear resistant inserts 30 arranged with their elongated extension 32 aligned with the normal N to the crushing surface 21 when worn, thus providing a larger surface of wear resistant material in the crushing surface 21 of the wear liners 10-a, 10-b.

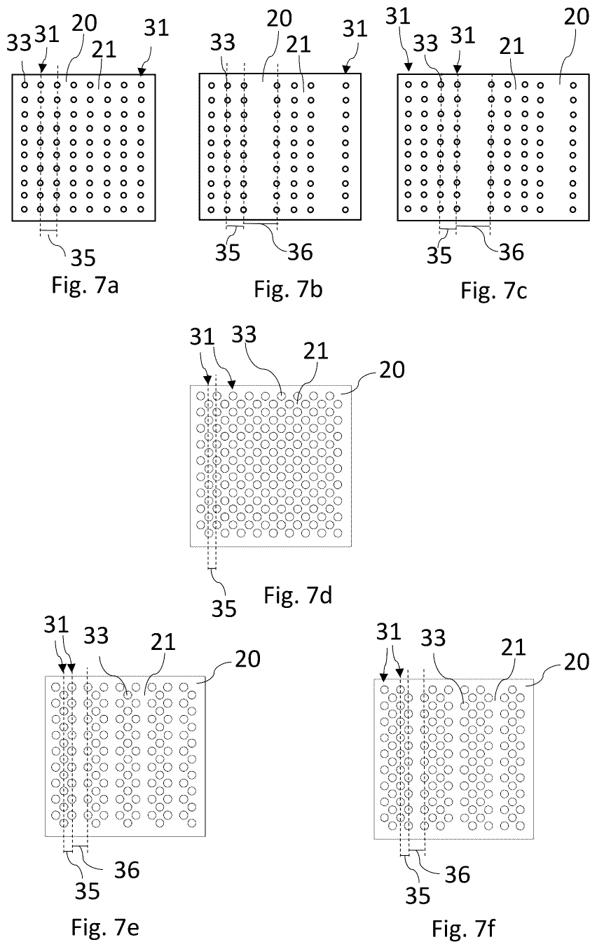

FIGS. 7a-7f show partial side views of crushing surfaces 21 of an inner wear liner 10-b showing examples of different patterns formed by the first ends 33 of the wear resistant inserts 30, arranged at or in the proximity to the crushing surface 21. As seen in FIGS. 7a-7f the wear resistant inserts 30 may be arranged in rows 31 aligned with the elongated extension 22 of the main body 20 and distributed around the circumferential extension of the main body 20. In FIGS. 7a and 7d, the rows 31 are arranged with a repeated distance 35. In FIG. 7a, the wear resistant inserts 30 are arranged such that the first ends 33 in the different rows 31 align with each other in a plane perpendicular 45 to the central longitudinal axis 25-b, while in FIG. 7d, the wear resistant inserts 30 are arranged such that the first ends 33 of adjacent rows 31 are staggered such that the first ends 33 of the wear resistant inserts 30 of every second row 31 are aligned with each other in a plane perpendicular 45 to the central longitudinal axis 25-b. In FIG. 7b, FIG. 7c, FIG. 7e, and FIG. 7f, the rows 31 are arranged with a repeated distance 35 regularly interrupted by a blank distance 36 which is larger than the repeated distance 35. In FIG. 7b, the blank distance 36 corresponds to removal of every 4th row of wear resistant inserts 30. In FIG. 7c, the blank distance 36 corresponds to removal of every 5th row of wear resistant inserts 30. FIG. 7e, showing a staggered pattern like FIG. 7d, shows a blank distance 36 corresponding to removal of every 4th row. FIG. 7f, also showing a staggered pattern like FIG. 7d, shows a blank distance 36 corresponding to removal of every 5^{th} row of wear resistant inserts 30. Thus, a blank distance 36 may correspond to a distance of at least one removed row 31 of wear resistant inserts 30 including the repeated distances 35 thereof, but a blank distance 36 may also correspond to more than one removed row 31, such as two removed adjacent rows 31 for every blank distance 36 and so forth. Further, other alternatives of repeated blank distances 36 may be envisaged, such as at least every 10th row, at least every 8th row, at least every 6th row, at least every 3rd row and so forth.

The patterns shown in FIGS. 7a-7f may also be applied in an outer wear liner 10-b.

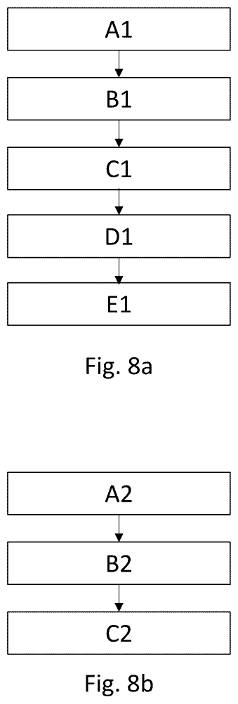

The novel and inventive wear liner 10-a, 10-b disclosed herein may be obtained by a method (see FIG. 8a) comprising providing a mould (A1) for casting the wear liner therein. Wear resistant inserts 30 can thereafter be arranged (B1) with their first ends 33 at a surface of the mould corresponding to a crushing surface 21 of the wear liner 10-a, 10-b, and with their elongated extension 32 arranged at an angle α, β to a normal of the mould surface which will correspond to a normal N of the crushing surface 21 of the produced wear liner 10-a, 10-b. Molten matrix material may then be cast into the mould (C1) such that the molten matrix material surrounds the wear resistant inserts 30, whereafter the molten matrix material is allowed to solidify (D1), thereby obtaining a wear liner 10 comprising wear resistant inserts 30 bonded to the solidified matrix material. After solidification of the matrix material, which forms the main body 20 of the wear liner 10, the mould is removed (E1) from the produced wear liner 10.

The wear resistant inserts 30 may be arranged at the mould surface by fasteners such as nails, and screws, which are fixed in the mould surface and removably fastened to the first ends 33 of the wear resistant inserts 30, e.g. by welding, such that upon or after casting of the matrix material in the mould, the fasteners are detached from the wear resistant inserts 30.

Alternatively, the wear liner 10 disclosed herein may be obtained by a method (see FIG. 8b) comprising providing a main body of a wear liner 10-a, 10-b (A2), forming holes (B2) in the crushing surface 21 of the wear liner 10 for receiving wear resistant inserts 30 therein, and fixedly inserting wear resistant inserts 30 into the holes (C2). In this embodiment, the holes are made with an elongated extension which elongated extension is at an angle α, β to a normal N of the crushing surface 21 of the wear liner 10-a, 10-b such that, upon insertion of the wear resistant inserts 30 therein, the elongated extension 32 of the wear resistant inserts 30 is at an angle α, β to a normal N of the crushing surface 21 of the wear liner 10-a, 10-b. The wear resistant inserts 30 may be fixed in the holes by means of an adhesive or by other fastening means known in the art.

The skilled person realises that a number of modifications of the embodiments described herein are possible without departing from the scope of the present disclosure, which is defined in the appended claims. For example, providing wear resistant inserts arranged with the elongated extension at an angle to a normal of the crushing surface in only a portion of the wear liner, e.g. a portion of the wear liner particularly exposed to wear, and providing wear resistant inserts arranged with the elongated extension in line with a normal of the crushing surface at other portions of the wear liner is also conceivable within the concept of the present disclosure. As a further example, it is also possible to alter the arrangement of the elongated extension of wear resistant inserts, e.g. where the wear resistant inserts are arranged in a pattern with rows, between rows such that, e.g. wear resistant inserts of every second row are arranged with the elongated extension at an angle to a normal of the crushing surface whereas the wear resistant inserts of the other rows are arranged with the elongated extension in line with a normal of the crushing surface.

1. A wear liner for a cone crusher comprising
a main body having a circumferential extension extending around a central longitudinal axis and having an elongated extension from a first axial end to a second axial end, the main body comprising a crushing surface to contact material to be crushed, which crushing surface is inclined with respect to the central longitudinal axis, and
wear resistant inserts embedded in the main body to strengthen the crushing surface, wherein
the wear resistant inserts have an elongated extension from a first end to a second end, and wherein
the elongated extension of the wear resistant inserts is arranged at an angle to a normal of the crushing surface.

2. The wear liner of claim 1, wherein the angle to the normal of the crushing surface is within the range of 5°-45°, 8°-45°, 10°-45°, 16°-45°, or 16°-30°.

3. The wear liner of claim 1, wherein the elongated extension of the wear resistant inserts is arranged at an angle to the normal of the crushing surface in a plane parallel with the central longitudinal axis and/or in a plane perpendicular to the central longitudinal axis.

4. The wear liner of claim 1, wherein the wear resistant inserts are embedded in the main body at the crushing surface in a pattern, wherein the pattern is formed by the first ends of the wear resistant inserts arranged at or in the proximity to the crushing surface arranged in rows aligned with the elongated extension of the main body, and wherein the rows are arranged with a repeated distance around the circumferential extension of the main body.

5. The wear liner of claim 1, wherein the wear resistant inserts are embedded in the main body at the crushing surface in a pattern, wherein the pattern is formed by the first ends of the wear resistant inserts, arranged at or in the proximity to the crushing surface, arranged in rows aligned with the elongated extension of the main body and distributed around the circumferential extension of the main body, and wherein the rows are arranged around the circumferential extension of the main body with a repeated distance regularly interrupted by a blank distance which is larger than the repeated distance.

6. The wear liner of claim 5, wherein the blank distance is repeated at least every 10^{th} row, at least every 8^{th} row, at least every 6^{th} row, at least every 4^{th} row, or at least every 3^{rd} row.

7. The wear liner of claim 5, wherein the blank distance corresponds to a distance of at least one removed row of wear resistant inserts including the repeated distances thereof.

8. The wear liner of claim 1, wherein the wear liner is an outer wear liner, wherein the crushing surface is provided at a radially inward facing surface of the wear liner, and wherein the outer wear liner during crushing is fixably mounted in a cone crusher for interaction with a moving element of the cone crusher which is arranged to rotate around its own central axis in a rotational direction.

9. The wear liner of claim 8, wherein the elongated extension (32) of the wear resistant inserts is, in comparison to the normal of the crushing surface, inclined, in a plane parallel with the central longitudinal axis, towards the first axial end of the main body.

10. The wear liner of claim 8, wherein the elongated extension of the wear resistant inserts is arranged at an angle to a normal of the crushing surface in a plane perpendicular to the central longitudinal axis and the first end of the wear resistant insert, at or in the proximity to the crushing surface, is arranged as a leading end in relation to a rotational direction of an interacting moving element of the cone crusher during crushing operation.

11. The wear liner claim 1, wherein the wear liner is an inner wear liner, wherein the crushing surface is provided at a radially outward facing surface of the wear liner, and wherein the inner wear liner during crushing operation will rotate around its own central longitudinal axis in a rotational direction.

12. The wear liner of claim 11, wherein the elongated extension of the wear resistant inserts is, in comparison to the normal of the crushing surface, inclined, in a plane parallel with the central longitudinal axis, towards the second axial end of the main body.

13. The wear liner of claim 11, wherein the elongated extension of the wear resistant inserts is arranged at an angle to a normal of the crushing surface in a plane perpendicular to the central longitudinal axis and the first end of the wear resistant insert, at or in the proximity to the crushing surface, is arranged as a leading end in relation to a rotational direction of the inner wear liner during crushing operation.

14. A cone crusher comprising at least one wear liner as claimed in claim 1.

15. A method of producing a wear liner for a cone crusher, the method comprising
providing a mould for casting the wear liner therein;
arranging wear resistant inserts having an elongated extension in the mould at a surface of the mould corresponding to a crushing surface of the wear liner;
pouring molten matrix material into the mould such that the molten matrix material surrounds the wear resistant inserts; and
allowing the matrix material to solidify, thereby obtaining a wear liner comprising wear resistant inserts bonded to the solidified matrix material,
wherein the step of arranging the wear resistant inserts in the mould comprises arranging the elongated extension of the wear resistant inserts at an angle to a normal of the mould surface.

16. A method of producing a wear liner for a cone crusher, the method comprising
providing a main body of a wear liner;
forming holes in a crushing surface of the wear liner for receiving wear resistant inserts therein; and
fixedly inserting wear resistant inserts having an elongated extension into the holes,
wherein the step of forming holes comprises forming an elongated extension of the holes which elongated extension is at an angle to a normal of the crushing surface of the wear liner, such that upon insertion of the wear resistant inserts in the holes, the elongated extension of the wear resistant inserts is at an angle to a normal of the crushing surface of the wear liner.
